(19) United States
(12) Patent Application Publication
(10) Pub. No.: US 2022/0036587 A1
(43) Pub. Date: Feb. 3, 2022

(54) CALIBRATION METHOD, ELECTRONIC DEVICE, AND STORAGE MEDIUM

(71) Applicant: Sensetime Group Limited, Shatin (CN)

(72) Inventors: Zheng MA, Hong Kong (CN); Rui HUANG, Hong Kong (CN); Guohang YAN, Hong Kong (CN); Jianping SHI, Hong Kong (CN)

(73) Assignee: Sensetime Group Limited, Shatin (CN)

(21) Appl. No.: 17/502,387

(22) Filed: Oct. 15, 2021

Related U.S. Application Data
(63) Continuation of application No. PCT/CN2020/142509, filed on Dec. 31, 2020.

(30) Foreign Application Priority Data
Mar. 13, 2020 (CN) 202010175090.3

(51) Int. Cl. G06T 7/80; G01B 11/00; G01C 11/04

(52) U.S. Cl. CPC G06T 7/80; G01C 11/04; G01B 11/002

(57) ABSTRACT

A calibration method, an electronic device, and a storage medium are provided. The calibration method includes the following. A sample image is acquired with an image acquisition device. Initial pixel coordinates of multiple sample reference objects in the sample image in an image coordinate system are determined based on the sample image. Straight-line fitting is performed on sample reference objects on a same straight line based on the determined initial pixel coordinates of the sample reference objects in the image coordinate system, and the initial pixel coordinates of the sample reference objects involved in straight-line fitting are corrected based on fitted straight lines to obtain corrected pixel coordinates. A homography matrix of the image acquisition device is determined based on world coordinates of the multiple sample reference objects in the sample image in a world coordinate system and the obtained corrected pixel coordinates.

### CROSS-REFERENCE TO RELATED APPLICATION(S)

This application is a continuation under 35 U.S.C. § 120 of International Application No. PCT/CN2020/142509, filed on Dec. 31, 2020, which claims priority under 35 U.S.C. § 119(a) and/or PCT Article 8 to Chinese Patent Application No. 202010175090.3, filed on Mar. 13, 2020, the disclosures of which are hereby incorporated by reference in their entireties.

### TECHNICAL FIELD

The present disclosure relates to the technical field of computer vision, and more particularly, to a calibration method, an electronic device, and a storage medium.

### BACKGROUND

With rapid development of artificial intelligence technologies, traditional industries and information technologies work together to bring convenience to people's lives. For example, with the combination of automotive industries and information technologies, intelligence vehicles capable of automatic driving have been produced. During automatic driving of intelligence vehicles, ranging is important. Among various ranging sensors for intelligence automobile driver-assistance, visual sensors can obtain richer information on road structure and environment and are relatively cheap.

Among vision ranging technologies, monocular-vision ranging technologies are widely used due to their advantages of low cost, simple system installation, and good stability etc. compared with multi-vision ranging technology. In monocular-vision ranging, a homography matrix is adopted. Based on a pixel coordinate of a target object in an image coordinate system and the homography matrix, a world coordinate of the target object in a world coordinate system can be obtained. Based on the world coordinate, information on a distance between the target object and a preset location can be obtained. Therefore, the accuracy of the homography matrix directly affects the accuracy of a ranging result.

The homography matrix is obtained by calibration in advance. During calibration, a world coordinate of a reference object in the world coordinate system is known, and the reference object needs to be selected from an image containing the reference object taken by an image acquisition device, to obtain a pixel coordinate of the reference object in the image coordinate system. Generally, the reference object needs to be manually selected from the image. Due to visual errors, the selection is inaccurate, which leads to an inaccurate calibration result.

### SUMMARY

According to a first aspect, a calibration method is provided. The calibration method includes the following. A sample image is acquired with an image acquisition device. Initial pixel coordinates of multiple sample reference objects in the sample image in an image coordinate system are determined based on the sample image. Straight-line fitting is performed on sample reference objects on a same straight line based on the determined initial pixel coordinates of the sample reference objects in the image coordinate system, and the initial pixel coordinates of the sample reference objects involved in straight-line fitting are corrected based on fitted straight lines to obtain corrected pixel coordinates. A homography matrix of the image acquisition device is determined based on world coordinates of the multiple sample reference objects in the sample image in a world coordinate system and the obtained corrected pixel coordinates.

According to a second aspect, an electronic device is provided. The electronic device includes a processor, a bus, and a storage. The storage is configured to store machine-readable instructions to be executed by the processor, where when the electronic device is running, the processor communicates with the storage through the bus, and the processor executes the machine-readable instructions to: acquire a sample image with an image acquisition device; determine initial pixel coordinates of multiple sample reference objects in the sample image in an image coordinate system based on the sample image; perform straight-line fitting on sample reference objects on a same straight line based on the determined initial pixel coordinates of the sample reference objects in the image coordinate system, and correct the initial pixel coordinates of the sample reference objects involved in straight-line fitting based on fitted straight lines to obtain corrected pixel coordinates; determine a homography matrix of the image acquisition device based on world coordinates of the multiple sample reference objects in the sample image in a world coordinate system and the obtained corrected pixel coordinates.

According to a third aspect, a non-transitory computer-readable storage medium is provided. The non-transitory computer-readable storage medium stores a computer program which, when executed by a processor, causes the processor to: acquire a sample image with an image acquisition device; determine initial pixel coordinates of multiple sample reference objects in the sample image in an image coordinate system based on the sample image; perform straight-line fitting on sample reference objects on a same straight line based on the determined initial pixel coordinates of the sample reference objects in the image coordinate system, and correct the initial pixel coordinates of the sample reference objects involved in straight-line fitting based on fitted straight lines to obtain corrected pixel coordinates; determine a homography matrix of the image acquisition device based on world coordinates of the multiple sample reference objects in the sample image in a world coordinate system and the obtained corrected pixel coordinates.

### BRIEF DESCRIPTION OF THE DRAWINGS

For describing the technical solutions of implementations of the present disclosure more clearly, the drawings required to be used in implementations will be simply introduced below. The drawings, which are incorporated in and constitute a part of this specification, illustrate implementations consistent with the present disclosure and, together with the specification, serve to explain the technical solutions of the present disclosure. It is to be understood that the following drawings only illustrate some implementations of the present disclosure and thus should not be considered as limits to the scope. Those of ordinary skill in the art may also obtain other related drawings according to these drawings without creative work.

FIG. 1 shows a flowchart of a calibration method according to implementations of the present disclosure.

FIG. 2 shows a schematic diagram of a sample reference object array in a world coordinate system according to implementations of the present disclosure.

FIG. 3 shows a sample image corresponding to a sample reference object array according to implementations of the present disclosure.

FIG. 4 shows a flowchart of a method for correcting an initial pixel coordinate(s) of a sample reference object(s) according to implementations of the present disclosure.

FIG. 5 shows a flowchart of a method for testing the accuracy of a homography matrix according to implementations of the present disclosure.

FIG. 6 shows a flowchart of a location determination method according to implementations of the present disclosure.

FIG. 7 shows a schematic structural diagram of a calibration apparatus according to implementations of the present disclosure.

FIG. 8 shows a schematic structural diagram of a location determination apparatus according to implementations of the present disclosure.

FIG. 9 shows a schematic structural diagram of an electronic device according to implementations of the present disclosure.

FIG. 10 shows a schematic structural diagram of an electronic device according to other implementations of the present disclosure.

### DETAILED DESCRIPTION

To make the purposes, technical solutions, and advantages of implementations of the present disclosure clearer, the technical solutions in the implementation will be clearly and completely described below in combination with the drawings in the implementation. It is apparent that the described implementations are not all implementations but only part of implementations of the present disclosure. Components, described and shown in the drawings, in the implementations of the present disclosure may usually be arranged and designed with various configurations. Therefore, the following detailed description for the implementations of the present disclosure in the drawings is not intended to limit the claimed scope of the present disclosure but only represents selected implementations of the present disclosure. Other implementations obtained by those of ordinary skill in the art based on the implementations of the present disclosure without creative work shall fall within the scope of the present disclosure.

At present, in the field of automatic driving and robotics, vision ranging is often carried out with an image acquisition device. The principle of vision ranging with the image acquisition device is as follows. A pixel coordinate of a target object captured by the image acquisition device in an image coordinate system is determined. A world coordinate of the target object in a world coordinate system is determined based on a homography matrix of the image acquisition device. A distance between a preset location and the target object is determined according to a world coordinate of the preset location and the world coordinate of the target object. The preset location can be the origin of the world coordinate system. Therefore, the accuracy of the homography matrix directly affects the accuracy of a ranging result. The homography matrix is obtained by calibration in advance. During calibration, a world coordinate of a reference object in the world coordinate system is known, and the reference object needs to be picked up from an image containing the reference object taken by an image acquisition device, to obtain a pixel coordinate of the reference object in the image coordinate system. Generally, the reference object needs to be manually selected from the image. Due to visual errors, the selection may be inaccurate, which leads to an inaccurate calibration result. In view of this, a method for correcting a pixel coordinate of a selected reference object is provided according to implementations of the present disclosure.

Based on the foregoing, a calibration method is provided. After a sample image containing sample reference objects is acquired with an image acquisition device, initial pixel coordinates of the sample reference objects in an image coordinate system are determined. Straight-line fitting is performed on sample reference objects in the sample image on a same straight line based on the initial pixel coordinates of the sample reference objects in the image coordinate system. The initial pixel coordinates of the sample reference objects involved in straight-line fitting are corrected based on fitted straight lines to obtain corrected pixel coordinates of the sample reference objects involved in straight-line fitting in the image coordinate system.

The sample reference objects can be placed in advance. For example, the sample reference objects can be arranged in a sample reference object array, so that sample reference objects in a same row or column are on a same straight line in the world coordinate system. The initial pixel coordinates of the sample reference objects in the image coordinate system can be corrected by performing straight-line fitting with the initial pixel coordinates of the sample reference objects in the image coordinate system, to obtain the corrected pixel coordinates with high accuracy of the sample reference objects in the image coordinate system. Then, according to the world coordinates of the sample reference objects in the sample reference object array in the world coordinate system and the corrected pixel coordinates of the sample reference objects in the image coordinate system, an accurate homography matrix of the image acquisition device can be obtained. In this way, the accuracy of calibration for the image acquisition device can be improved.

It should be noted that in the drawings, similar reference numbers indicate similar items. Therefore, once a certain item is defined in one drawing, it does not need to be further defined and explained in subsequent drawings.

For better understanding of implementations, a calibration method according to implementations of the present disclosure is first illustrated in detail. Generally, the calibration method provided is executed by a computer device with data processing capabilities.

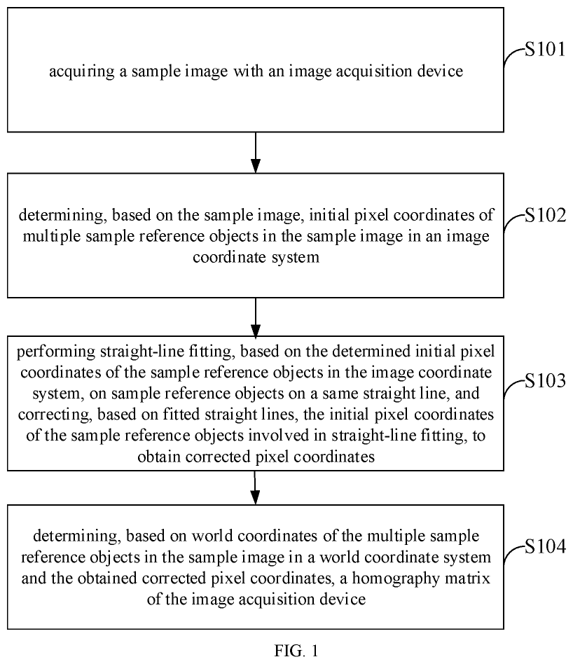

FIG. 1 is a schematic flowchart of a calibration method according to implementations of the present disclosure. The calibration method begins at S101.

At S101, a sample image is acquired with an image acquisition device.

At S102, initial pixel coordinates of multiple sample reference objects in the sample image in an image coordinate system are determined based on the sample image.

At S103, straight-line fitting is performed on sample reference objects on a same straight line based on the determined initial pixel coordinates of the sample reference objects in the image coordinate system, and the initial pixel coordinates of the sample reference objects involved in straight-line fitting are corrected based on fitted straight lines to obtain corrected pixel coordinates.

At S104, a homography matrix of the image acquisition device is determined based on world coordinates of the multiple sample reference objects in the sample image in a world coordinate system and the obtained corrected pixel coordinates.

The above S101-S104 are respectively described below.

At S101, the sample image can be acquired with the image acquisition device as follows. The sample image can be acquired by shooting a sample reference object array with the image acquisition device. An image acquisition environment and a world coordinate system where sample reference objects are located can be set in advance. For example, the image acquisition environment can be set by drawing multiple straight lines on the ground or looking for a place containing multiple lane lines to form multiple straight lines L, and placing the sample reference objects of a same shape on each straight line L. For example, the sample reference objects can be cone sample reference objects. The sample reference objects can be divided into multiple groups, and each group of sample reference objects are located on a same straight line L. In addition, multiple straight lines H need to be provided so that each straight line H intersects each straight line L. The sample reference objects are placed at intersections of the straight lines L and the straight lines H to obtain the sample reference object array. The sample reference object array includes the sample reference objects collinear on both the multiple straight lines L and the multiple straight lines H.

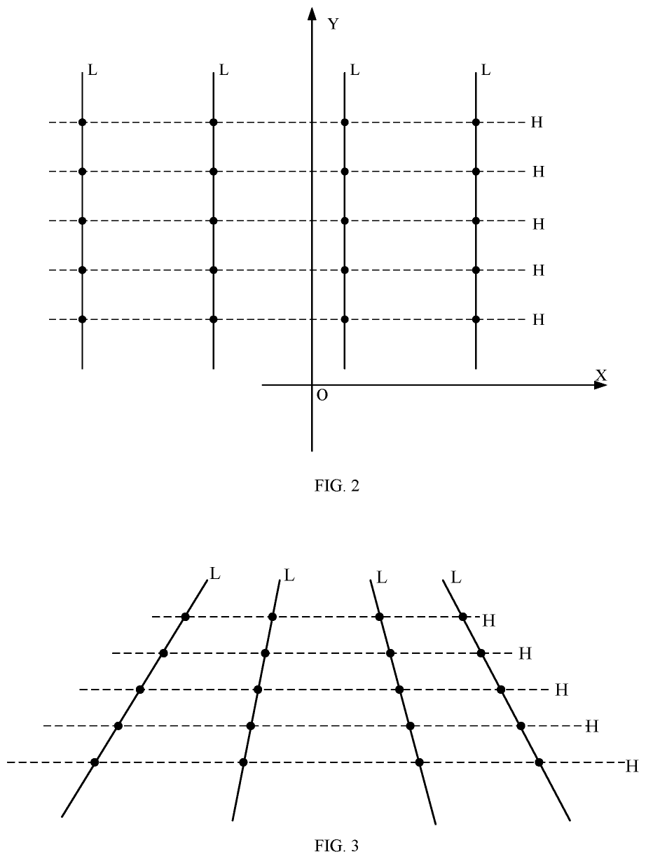

In some examples, a world coordinate system is established with a mapping point of the center of a front axle of a vehicle or the center of the body of the vehicle on the ground as the origin. The origin is a set location point, and the image acquisition device is located at a set location of the vehicle. In this way, a world coordinate system as shown in FIG. 2 is established. For simplicity, each straight line L is parallel to the Y axis of the world coordinate system and each straight line H is parallel to the X axis of the world coordinate system.

In some examples, a camera of the image acquisition device on the vehicle is adjusted to be parallel to the ground. When the image acquisition device shoots the sample reference object array in a Y-axis direction, a sample image as shown in FIG. 3 can be obtained.

At S102, after the sample image of the sample reference objects is obtained, the sample image can be placed in the image coordinate system. Based on the location where a cone sample reference object, which is manually selected by a user in the image coordinate system, is tangent to the ground, the initial pixel coordinate of the cone sample reference object in the image coordinate system can be determined. Alternatively, the sample image can be input into a pixel coordinate determination model trained in advance to determine the initial pixel coordinate of each sample reference object.

The pixel coordinate determination model can be configured to perform image recognition based on the sample image to determine, for each cone sample reference object, the location where the cone sample reference object is tangent to the ground, the location thus determined is the location of the cone sample reference object in the image; then determine the initial pixel coordinate of the cone sample reference object in the image coordinate system based on the location of the cone sample reference object in the image.

At S103, in the world coordinate system, sample reference objects on each straight line L are collinear, sample reference objects on each straight line H are collinear, and each sample reference object is located at an intersection of a straight line L and a straight line H. In view of this, straight-line fitting can be performed on the sample reference object array in the sample image to correct the initial pixel coordinate of each sample reference object.

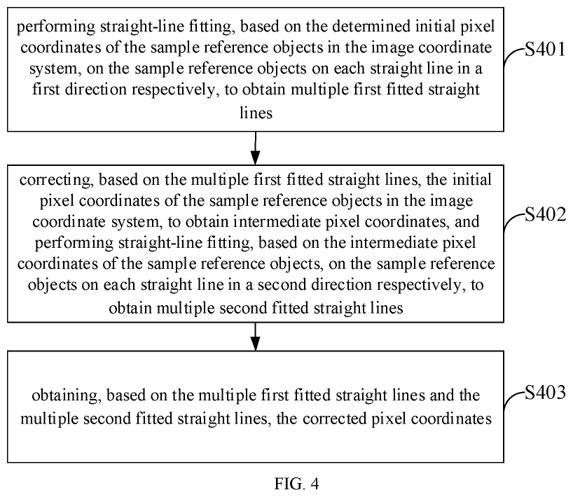

As shown in FIG. 4, straight-line fitting can be performed on the sample reference objects on the same straight line based on the determined initial pixel coordinates of the sample reference objects in the image coordinate system, and the initial pixel coordinates of the sample reference objects involved in straight-line fitting can be corrected based on the fitted straight lines to obtain the corrected pixel coordinates as follows.

At S401, straight-line fitting is performed on the sample reference objects on each straight line in a first direction respectively based on the determined initial pixel coordinates of the sample reference objects in the image coordinate system, to obtain multiple first fitted straight lines.

Line segments between sample reference objects on one first fitted straight line do not intersect line segments between sample reference objects on another first fitted straight line. For example, the multiple first fitted straight lines are parallel to each other, or the multiple first fitted straight lines intersect in the distance but do not intersect at a position where the sample reference objects are located.

The determined initial pixel coordinates may be inaccurate due to visual errors or errors of the pixel coordinate determination model. As a result, the initial pixel coordinates that should be on a same straight line may not be on the same straight line. In view of this, straight-line fitting can be performed with the initial pixel coordinates to obtain the multiple first fitted straight lines.

After straight-line fitting is performed on the sample reference objects on each straight line in the first direction respectively, line segments between sample reference objects on one first fitted straight line do not intersect line segments between sample reference objects on another first fitted straight line. For example, after straight-line fitting is performed on the sample reference objects, multiple first fitted straight lines corresponding to straight lines L in FIG. 3 are obtained, or multiple first fitted straight lines corresponding to straight lines H in FIG. 3 are obtained.

For example, first straight-line fitting can be performed on sample reference objects on straight lines in the first direction as follows. The sample reference objects in the sample image can be divided into multiple groups of sample reference objects. Each group of sample reference objects belong to a same straight line in the world coordinate system. In one case, the sample reference objects can be grouped according to which straight line L they belong to in the world coordinate system. That is, sample reference objects belonging to a same straight line L in the world coordinate system are divided into one group. In another case, the sample reference objects can be grouped according to which straight line H they belong to in the world coordinate system. That is, sample reference objects belonging to a same straight line H in the world coordinate system are divided into one group.

Taking the latter case as an example, the sample reference objects belonging to the same straight line L in the world coordinate system are divided into one group. For example, in the sample image shown in FIG. 3, the sample reference objects in the sample reference object array are divided into four groups of sample reference objects according to which straight line L they belong to. Straight-line fitting can be performed with initial pixel coordinates corresponding to the four groups of sample reference objects respectively to obtain four first fitted straight lines.

For each group of sample reference objects, first straight-line fitting can be performed with the initial pixel coordinates of the group of sample reference objects by adopting the least square method. A first straight-line equation corresponding to a first fitted straight line can be obtained according to the following equations (1) -(3):

$$\begin{matrix}{min}_{{b}_{0} , {b}_{1}} {‖ ( \begin{matrix}1 & {x}_{1} \\ … & … \\ 1 & {x}_{n}\end{matrix} ) ( \begin{matrix}{b}_{0} \\ {b}_{1}\end{matrix} ) - \begin{matrix}{y}_{1} \\ {y}_{2} \\ {y}_{3}\end{matrix} ‖}_{2} = {min}_{b} {‖ Ab - Y ‖}_{2} , & ( 1 ) \\ {b}_{1} = \frac{{{\sum }_{i = 1}}^{n} {y}_{i} {x}_{i} - n * \overline{x} \cdot \overline{y}}{{{\sum }^{n}}_{i = 1} {{x}_{i}}^{2} - n * {( \overline{x} )}^{2}} , & ( 2 ) \\ {b}_{0} = \overline{y} - {b}_{1} \overline{x} , & ( 3 )\end{matrix}$$

where (xᵢ, yᵢ) indicates an initial pixel coordinate of the i-th sample reference object in the group of sample reference objects, n indicates the number of sample reference objects in the group, x̅ indicates an average value of initial horizontal coordinate values corresponding to the group of sample reference objects, y̅ indicates an average value of initial vertical coordinate values corresponding to the group of sample reference objects, and b, b₀, and b₁ are unknown parameters in the first straight-line equation.

For each group of sample references objects, after the initial pixel coordinates corresponding to the group of sample reference objects are substituted into equations (1)-(3), the unknown parameters b0 and b₁ in the first straight-line equation corresponding to the group of sample reference objects can be obtained. In this way, the first straight-line equation, y=b₁x−b₀, of the first fitted straight line corresponding to the group of sample reference objects can be obtained.

At S402, the initial pixel coordinates of the sample reference objects in the image coordinate system are corrected based on the multiple first fitted straight lines to obtain intermediate pixel coordinates, and straight-line fitting is performed on the sample reference objects on each straight line in a second direction respectively based on the intermediate pixel coordinates of the sample reference objects to obtain multiple second fitted straight lines.

Each straight line in the first direction intersects each straight line in the second direction.

Each initial pixel coordinate includes an initial first coordinate value and an initial second coordinate value. A first coordinate axis corresponding to the initial first coordinate value is perpendicular to a second coordinate axis corresponding to the initial second coordinate value.

The initial pixel coordinates of the sample reference objects in the image coordinate system can be corrected based on the multiple first fitted straight lines to obtain the intermediate pixel coordinates as follows. For each sample reference object, the initial first coordinate value of the initial pixel coordinate is substituted into a straight-line equation of the first fitted straight line where the sample reference object is located to obtain an intermediate second coordinate value. The intermediate pixel coordinate of the sample reference object includes the initial first coordinate value and the intermediate second coordinate value of the sample reference object. The process of correcting the initial pixel coordinates to obtain the intermediate pixel coordinates can be regarded as the process of correcting the initial second coordinate values of the sample reference objects.

In the image coordinate system, the first coordinate axis may be a horizontal axis or a vertical axis. When the first coordinate axis is the horizontal axis of the image coordinate system, the second coordinate axis is the vertical axis of the image coordinate system. Alternatively, when the first coordinate axis is the vertical axis of the image coordinate system, the second coordinate axis is the horizontal axis of the image coordinate system.

For example, the sample image in FIG. 3 contains a total of twenty sample reference objects, and the initial pixel coordinates of these twenty sample reference objects are respectively (x₁, y₁)˜(x₂₀, y₂₀). The initial first coordinate values of the sample reference objects are x₁˜x₂₀, and the initial second coordinate values of the sample reference objects are y₁˜y₂₀. In this case, the first coordinate axis corresponding to the initial first coordinate values is the horizontal axis of the image coordinate system, and the second coordinate axis corresponding to the initial second coordinate values is the vertical axis of the image coordinate system. Alternatively, the initial first coordinate values of the sample reference objects are y₁˜y₂₀, and the initial second coordinate values of the sample reference objects are x₁˜x₂₀. In this case, the first coordinate axis corresponding to the initial first coordinate values is the vertical axis of the image coordinate system, and the second coordinate axis corresponding to the initial second coordinate values is the horizontal axis of the image coordinate system.

The initial first coordinate value substituted into the straight-line equation of the first fitted straight line can be the initial horizontal coordinate value corresponding to the horizontal axis or the initial vertical coordinate value corresponding to the ordinate axis. In many historical experiments, it has been found that no matter whether the initial pixel coordinate is obtained by manually marking the sample reference object in the sample image or determined with the pixel coordinate determination model, in a determined initial pixel coordinate, the accuracy of an initial horizontal coordinate value is higher than the accuracy of an initial vertical coordinate value. Therefore, in implementations of the present disclosure, initial vertical coordinate values will be corrected first due to their low accuracy. That is, for each sample reference object, the initial horizontal coordinate value of the initial pixel coordinate is substituted into the straight-line equation of the first fitted straight line where the sample reference object is located to obtain the intermediate second coordinate value. The intermediate second coordinate value is the corrected vertical coordinate value corresponding to the initial vertical coordinate value of the initial pixel coordinate of the sample reference object.

For each sample reference object, the initial first coordinate value and the intermediate second coordinate value constitute the intermediate pixel coordinate. For example, the initial pixel coordinates of the twenty sample reference objects are (x₁, y₁)˜(y₂₀, y₂₀), and after correction as described above, the intermediate pixel coordinates (x₁, y₁′)˜(x₂₀, y₂₀′) of the twenty sample reference objects are obtained.

Straight-line fitting can be performed on the sample reference objects on each straight line in the second direction respectively based on the intermediate pixel coordinates of the sample reference objects to obtain the multiple second fitted straight lines as follows. Straight-line fitting is performed on the sample reference objects on each straight line in the second direction respectively based on the initial first coordinate values and the intermediate second coordinate values in the intermediate pixel coordinates of the sample reference objects to obtain the multiple second fitted straight lines.

Line segments between sample reference objects on one second fitted straight line do not intersect line segments between sample reference objects on another second fitted straight line. Line segments between sample reference objects on each second fitted straight line intersect line segments between sample reference objects on multiple first fitted straight lines.

After straight-line fitting is performed on the sample reference objects on each straight line in the second direction respectively based on the intermediate pixel coordinates of the sample reference objects, line segments between sample reference objects on one second fitted straight line do not intersect line segments between sample reference objects on another second fitted straight line. For example, if first straight-line fitting is performed on the sample reference objects to obtain multiple first fitted straight lines corresponding to the straight lines L in FIG. 3, second straight-line fitting will be performed on the sample reference objects to obtain multiple second fitted straight lines corresponding to the straight lines H in FIG. 3. Alternatively, if first straight-line fitting is performed on the sample reference objects to obtain multiple first fitted straight lines corresponding to the straight lines H in FIG. 3, second straight-line fitting will be performed on the sample reference objects to obtain multiple second fitted straight lines corresponding to the straight lines L in FIG. 3.

For example, second straight-line fitting can be performed to obtain the multiple second fitted straight lines as follows. The sample reference objects in the sample reference object array can be divided into multiple groups of sample reference objects. Each group of sample reference objects belong to a same straight line in the world coordinate system. In one case, when first straight-line fitting is performed, the sample reference objects are grouped according to which straight line L they belong to in the world coordinate system. Then, when second straight-line fitting is performed, the sample reference objects are grouped according to which straight line H they belong to in the world coordinate system. In another case, when first straight-line fitting is performed, the sample reference objects will be grouped according to which straight line H they belong to in the world coordinate system. Then, when second straight-line fitting is performed, the sample reference objects will be grouped according to which straight line L they belong to in the world coordinate system.

For example, to obtain multiple first fitted straight lines, the sample reference objects are grouped according to which straight line L they belong to in the world coordinate system. Then, to obtain multiple second fitted straight lines, the sample reference objects are grouped according to which straight line H they belong to in the world coordinate system. That is, sample reference objects belonging to a same straight line H in the world coordinate system are divided into one group. For example, for the sample image shown in FIG. 3, before straight-line fitting is performed on sample reference objects on straight lines in the second direction, the sample reference objects are divided into five groups of sample reference objects. Straight-line fitting can be performed on each group to obtain five fitted straight lines.

For each group of sample reference objects, second straight-line fitting can be performed with the intermediate pixel coordinates of the group of sample reference objects by adopting the least square method. A second straight-line equation corresponding to a second fitted straight line can be obtained according to the following equations (4) -(6):

$$\begin{matrix}{min}_{{b}_{2} , {b}_{3}} {‖ ( \begin{matrix}1 & {x}_{1} \\ … & … \\ 1 & {x}_{n}\end{matrix} ) ( \begin{matrix}{b}_{2} \\ {b}_{3}\end{matrix} ) - \begin{matrix}{{y}_{1}}^{′} \\ {{y}_{2}}^{′} \\ {{y}_{3}}^{′}\end{matrix} ‖}_{2} = {min}_{b} {‖ Ab - {Y}^{′} ‖}_{2} , & ( 4 ) \\ {b}_{3} = \frac{{{\sum }_{i = 1}}^{n} {{y}_{i}}^{′} {x}_{i} - n * \overline{x} \cdot {\overline{y}}^{′}}{{{\sum }^{n}}_{i = 1} {{x}_{i}}^{2} - n * {( \overline{x} )}^{2}} , & ( 5 ) \\ {b}_{2} = {\overline{y}}^{′} - {b}_{3} \overline{x} , & ( 6 )\end{matrix}$$

where (xᵢ, yᵢ′) indicates an intermediate pixel coordinate of the i-th sample reference object in the group of sample reference objects, the intermediate pixel coordinate includes an initial horizontal coordinate value and an intermediate vertical coordinate value, n indicates the number of sample reference objects in the group, x̅ indicates an average value of initial horizontal coordinate values corresponding to the group of sample reference objects, y̅′ indicates an average value of intermediate vertical coordinate values corresponding to the group of sample reference objects, the intermediate vertical coordinate values are obtained by correcting the initial vertical coordinate values after first straight-line fitting is performed on the sample reference objects, and b, b₂, and b₃ are unknown parameters in the second straight-line equation.

For each group of sample references objects, after the intermediate pixel coordinates corresponding to the group of sample reference objects are substituted into equations (4) -(6), the unknown parameters b₂ and b₃ in the second straight-line equation corresponding to the group of sample reference objects can be obtained. In this way, the second straight-line equation, y=b₃x-b₂, of the second fitted straight line corresponding to the group of sample reference objects can be obtained.

At S403, the corrected pixel coordinates are obtained based on the multiple first fitted straight lines and the multiple second fitted straight lines.

Pixel coordinates corresponding to intersections of the multiple first fitted straight lines and the multiple second fitted straight lines can be assigned as the corrected pixel coordinates.

The corrected pixel coordinates of the sample reference objects in the sample reference object array can be obtained by calculating coordinate values of the intersections of the first fitted straight lines and the second fitted straight lines with corresponding first straight-line equations and second straight-line equations. For example, the intermediate pixel coordinates of the twenty sample reference objects are (x₁, y₁′)˜(x₂₀, y₂₀′), and after correction as described above, the corrected pixel coordinates (xᵢ″, yᵢ″)˜(x₂₀, y₂₀′) of the twenty sample reference objects are obtained.

According to S401-S403, the initial pixel coordinates of the sample reference objects can be corrected to obtain the corrected pixel coordinates as follows. The initial pixel coordinates of the sample reference objects can be corrected based on different straight lines to which the sample reference objects belong. For example, straight lines in two different directions are selected for correcting the initial pixel coordinates of the sample reference objects to obtain the corrected pixel coordinates with high accuracy. During the correction of the initial pixel coordinates of the sample reference objects, for each initial pixel coordinate, one coordinate value in the initial pixel coordinate is corrected, and then the other coordinate value in the initial pixel coordinate is corrected. In this way, a corrected coordinate with high accuracy can be obtained.

As for S104, after the corrected pixel coordinates of the sample reference objects in the image coordinate system are obtained, the homography matrix of the image acquisition device can be determined based on the world coordinates of the sample reference objects in the world coordinate system and the corrected pixel coordinates of the sample reference objects in the image coordinate system. For example, a pixel coordinate matrix of the corrected pixel coordinates of the sample reference objects in the image coordinate system can be constructed. A world coordinate matrix of the world coordinates of the sample reference objects in the world coordinate system can be constructed. Then, the pixel coordinate matrix and world coordinate matrix known as well as the homography matrix of the image acquisition device unknown are substituted into a conversion equation for the image acquisition device between pixel coordinates and world coordinates to determine the homography matrix of the image acquisition device.

For example, the world coordinates of the sample reference objects in the sample reference object array in the world coordinate system are denoted as (X₁, Y₁)˜(Xₙ, Yₙ), the world coordinate matrix is denoted as A, the pixel coordinate matrix is denoted as C, and the homography matrix is denoted as B, which are expressed as follows:

$$A = [ \begin{matrix}{X}_{1} & … & {X}_{n} \\ {Y}_{1} & … & {Y}_{n} \\ 1 & … & 1\end{matrix} ] , B = [ \begin{matrix}{h}_{11} & {h}_{12} & {h}_{12} \\ {h}_{21} & {h}_{22} & {h}_{23} \\ {h}_{31} & {h}_{32} & {h}_{33}\end{matrix} ] , A = [ \begin{matrix}{{x}_{1}}^{″} & … & {{x}_{n}}^{″} \\ {{y}_{1}}^{″} & … & {{y}_{n}}^{″} \\ 1 & … & 1\end{matrix} ] .$$

Then, the world coordinate matrix A, the pixel coordinate matrix C, and the homography matrix B are substituted into the conversion equation for the image acquisition device between pixel coordinates and world coordinates. The conversion equation is expressed as the following equation (7):

A=B×C (7).

The conversion equation is solved to obtain the homography matrix of the image acquisition device as follows: B=(AA^{T}))*(CA^{T})⁻¹.

In implementations of the present disclosure, the initial pixel coordinates of the sample reference objects in the image coordinate system can be corrected to obtain the corrected pixel coordinates with high accuracy of the sample reference objects in the image coordinate system. Then, according to the world coordinates of the sample reference objects in the sample reference object array in the world coordinate system and the corrected pixel coordinates of the sample reference objects in the image coordinate system, an accurate homography matrix of the image acquisition device can be obtained. In this way, the accuracy of calibration for the image acquisition device can be improved.

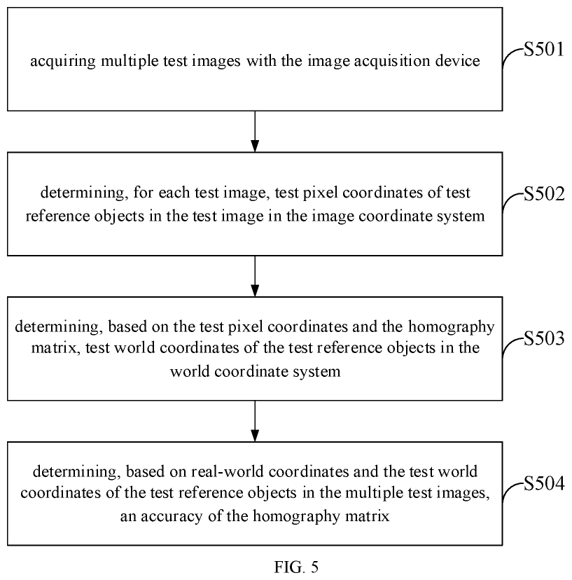

Further, as shown in FIG. 5, after the homography matrix of the image acquisition device is determined, an accuracy of the determined homography matrix can be tested. The test begins at S501.

At S501, multiple test images are acquired with the image acquisition device after the homography matrix of the image acquisition device is determined.

This image acquisition device is the same type as the image acquisition device mentioned above, and shooting angles for the multiple test reference object arrays are the same as that for the sample reference object array mentioned above.

The process of setting test reference objects is similar to sample reference objects, which will not be repeated here. Multiple different test reference object arrays can be set, so that the image acquisition device can shoot for each test reference object array to obtain multiple test images.

At S502, for each test image, test pixel coordinates of test reference objects in the test image in the image coordinate system are determined.

A method for determining the test pixel coordinates of the test reference objects in the test image in the image coordinate system here is the same as the method for determining the corrected pixel coordinates of the sample reference objects in the sample image in the image coordinate system described above, which will not be repeated.

At S503, test world coordinates of the test reference objects in the world coordinate system are determined based on the test pixel coordinates and the homography matrix.

For each test image, after the test pixel coordinates of the test reference objects are obtained, horizontal coordinate values and vertical coordinate values in the test pixel coordinates constitute a test pixel coordinate matrix. The test pixel coordinate matrix and the homography matrix are input to the conversion equation for the image acquisition device between pixel coordinates and world coordinates to obtain the test world coordinates of the test reference objects in the test image in the world coordinate system.

At S504, an accuracy of the homography matrix is determined based on real-world coordinates and the test world coordinates of the test reference objects in the multiple test images.

For each test image, the real-world coordinates of the test reference objects are compared with the test world coordinates respectively to determine whether the test world coordinates of the test reference objects in the test image are accurate. A ratio of the number of test reference objects with accurate test world coordinates to the total number of test reference objects is assigned as the accuracy of the homography matrix.

In implementations of the present disclosure, the accuracy of the homography matrix is checked to determine whether the accuracy of the obtained homography matrix meets a set condition. When the accuracy of the homography matrix does not meet the set condition, the homography matrix can be corrected in time. For example, the calibration process for the image acquisition device will be executed again, that is, operations of S101-S104 will be executed again to obtain a homography matrix with higher accuracy, thereby ensuring that the ranging with the image acquisition device is accurate.

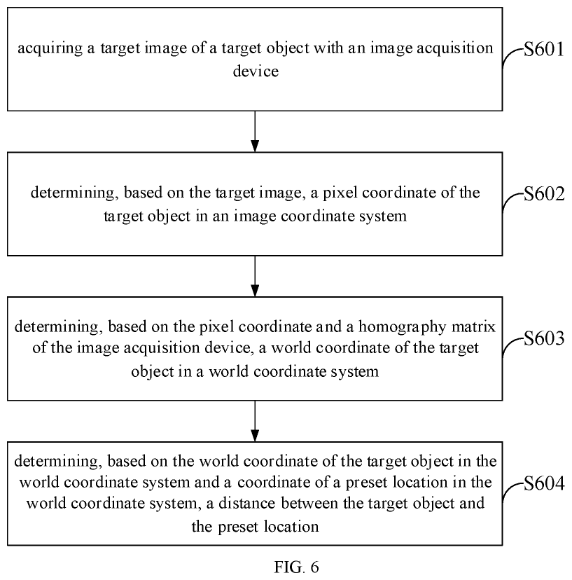

Further, after the homography matrix of the image acquisition device is determined, a location of a target object can be determined based on the homography matrix as follows. FIG. 6 is a flowchart of a location determination method according to implementations of the present disclosure. The location determination method begins at S601.

At S601, a target image of a target object is acquired with an image acquisition device.

At S602, a pixel coordinate of the target object in an image coordinate system is determined based on the target image.

At S603, a world coordinate of the target object in a world coordinate system is determined based on the pixel coordinate and a homography matrix of the image acquisition device.

At S604, a distance between the target object and the preset location is determined based on the world coordinate of the target object in the world coordinate system and a coordinate of a preset location in the world coordinate system.

Taking a vehicle as an example, the preset location can be at the projection of the center of a front axle of the vehicle on the ground, or at the projection of the center of the body of the vehicle on the ground. When the preset location is set as the origin, a world coordinate of the origin in the world coordinate system is known. The preset location can be used as a vehicle ranging point for ranging between the target object and the vehicle.

After the homography matrix of the image acquisition device is obtained, operations of S601-S604 are executed for ranging with the homography matrix. The target object in the target image has an area. After the target image is obtained, a ranging point of the target object can be determined according to the target image. Then, a distance between the target object and the vehicle can be determined based on world coordinates of the ranging point and the preset location in the world coordinate system.

In some examples, after the target image of the target object is obtained, a marking box for the target object can be obtained based on image recognition technologies. During the calibration for the image acquisition device, to determine the homography matrix of the image acquisition device, the location where a selected cone reference object is tangent to the ground is determined as the location of the reference object. Similarly, the ranging point of the target object should be selected as a point on a tangent line between the marking box and the ground in the target image. For example, a center point of the tangent line between the marking box and the ground can be selected as the ranging point. Then, a pixel coordinate of the ranging point can be used as the pixel coordinate of the target object in the image coordinate system.

After the pixel coordinate of the target object in the image coordinate system is obtained, the pixel coordinate of the target object in the image coordinate system and the homography matrix are input into the conversion equation for the image acquisition device between pixel coordinates and world coordinates to obtain the world coordinate of the target object in the world coordinate system. According to the world coordinate of the target object in the world coordinate system and the world coordinate of the preset location, a Euclidean distance between the target object and the preset location can be calculated to determine the distance between the target object and the vehicle.

In implementations of the present disclosure, after the homography matrix with high accuracy is obtained, the homography matrix can be used to accurately determine the world coordinate of the target object in the world coordinate system, and then the distance to the target object.

In conclusion, according to the calibration method provided, after the sample image of the sample reference objects is acquired with the image acquisition device, the initial pixel coordinates of the sample reference objects in the image coordinate system are determined. Straight-line fitting is performed on the sample reference object array in the sample image based on the initial pixel coordinates of the sample reference objects in the image coordinate system. The initial pixel coordinates are corrected based on the fitted straight lines to obtain the corrected pixel coordinates of the sample reference objects in the image coordinate system.

The sample reference objects can be placed in advance. For example, the sample reference objects can be arranged in a sample reference object array, so that sample reference objects in a same row or column are on a same straight line in the world coordinate system. The initial pixel coordinates of the sample reference objects in the image coordinate system can be corrected by performing straight-line fitting with the initial pixel coordinates of the sample reference objects in the image coordinate system to obtain the corrected pixel coordinates with high accuracy of the sample reference objects in the image coordinate system. Then, according to the world coordinates of the sample reference objects in the sample reference object array in the world coordinate system and the corrected pixel coordinates of the sample reference objects in the image coordinate system, an accurate homography matrix of the image acquisition device can be obtained. In this way, the accuracy of calibration for the image acquisition device can be improved.

It can be understood by those of ordinary skill in the art that, in the method in the implementations, the sequence of each step does not refer to a strict execution sequence and is not intended to limit the implementation process and a specific execution sequence of each step should be determined by functions and probable internal logic thereof.

Based on the same concept, a calibration apparatus corresponding to the calibration method is provided according to implementations of the present disclosure. The principle of the calibration apparatus to solve the problem is similar to that of the calibration method. Therefore, implementations of the calibration apparatus can refer to implementations of the calibration method, which will not be repeated here.

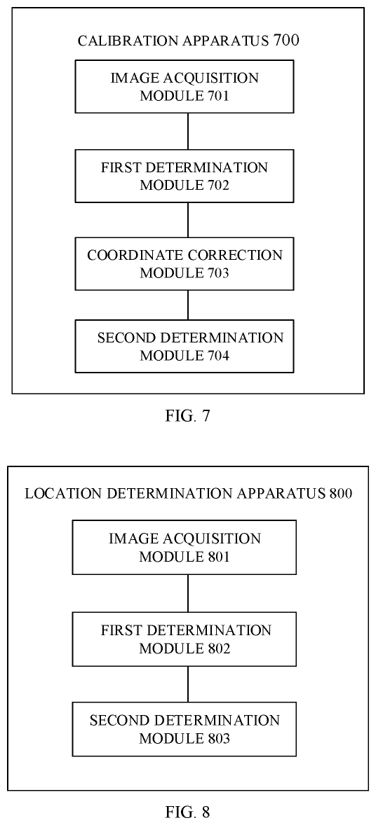

FIG. 7 is a schematic structural diagram of a calibration apparatus 700 according to implementations of the present disclosure. The calibration apparatus 700 includes an image acquisition module 701, a first determination module 702, a coordinate correction module 703, and a second determination module 704. The image acquisition module 701 is configured to acquire a sample image with an image acquisition device. The first determination module 702 is configured to determine initial pixel coordinates of multiple sample reference objects in the sample image in an image coordinate system based on the sample image. The a coordinate correction module 703 is configured to perform straight-line fitting on sample reference objects on a same straight line based on the determined initial pixel coordinates of the sample reference objects in the image coordinate system, and correct the initial pixel coordinates of the sample reference objects involved in straight-line fitting based on fitted straight lines to obtain corrected pixel coordinates. The second determination module 704 is configured to determine a homography matrix of the image acquisition device based on world coordinates of the multiple sample reference objects in the sample image in a world coordinate system and the obtained corrected pixel coordinates.

In an implementation, the coordinate correction module 703 is configured to: perform straight-line fitting on the sample reference objects on each straight line in a first direction respectively based on the determined initial pixel coordinates of the sample reference objects in the image coordinate system to obtain a multiple first fitted straight lines, correct the initial pixel coordinates of the sample reference objects in the image coordinate system based on the multiple first fitted straight lines to obtain intermediate pixel coordinates, and perform straight-line fitting on the sample reference objects on each straight line in a second direction respectively based on the intermediate pixel coordinates of the sample reference objects to obtain multiple second fitted straight lines, where each straight line in the first direction intersects each straight line in the second direction, and obtain the corrected pixel coordinates based on the multiple first fitted straight lines and the multiple second fitted straight lines.

In an implementation, each initial pixel coordinate includes an initial first coordinate value and an initial second coordinate value, and a first coordinate axis corresponding to the initial first coordinate value is perpendicular to a second coordinate axis corresponding to the initial second coordinate value. The coordinate correction module 703 configured to correct the initial pixel coordinates of the sample reference objects in the image coordinate system based on the multiple first fitted straight lines to obtain the intermediate pixel coordinates is configured to: for each sample reference object, substitute the initial first coordinate value of the initial pixel coordinate into a straight-line equation of the first fitted straight line where the sample reference object is located to obtain an intermediate second coordinate value, where the intermediate pixel coordinate of the sample reference object includes the initial first coordinate value and the intermediate second coordinate value of the sample reference object. The coordinate correction module 703 configured to perform straight-line fitting on the sample reference objects on each straight line in the second direction respectively based on the intermediate pixel coordinates of the sample reference objects to obtain the multiple second fitted straight lines is configured to: perform straight-line fitting on the sample reference objects on each straight line in the second direction respectively based on the initial first coordinate values and the intermediate second coordinate values in the intermediate pixel coordinates of the sample reference objects to obtain the multiple second fitted straight lines.

In an implementation, the coordinate correction module 703 configured to obtain the corrected pixel coordinates based on the multiple first fitted straight lines and the multiple second fitted straight lines is configured to: assign pixel coordinates corresponding to intersections of the multiple first fitted straight lines and the multiple second fitted straight lines as the corrected pixel coordinates.

In an implementation, the first coordinate axis is a horizontal axis of the image coordinate system and the second coordinate axis is a vertical axis of the image coordinate system, or the first coordinate axis is the vertical axis of the image coordinate system and the second coordinate axis is the horizontal axis of the image coordinate system.

In an implementation, the second determination module 704 is further configured to: acquire multiple test images with the image acquisition device after determining the homography matrix of the image acquisition device, determine, for each test image, test pixel coordinates of test reference objects in the test image in the image coordinate system, determine test world coordinates of the test reference objects in the world coordinate system based on the test pixel coordinates and the homography matrix, and determine an accuracy of the homography matrix based on real-world coordinates and the test world coordinates of the test reference objects in the multiple test images.

As shown in FIG. 8, a location determination apparatus 800 is provided according to implementations of the present disclosure. The homography matrix of the image acquisition device determined with the calibration apparatus mentioned above is used to locate a target object captured by the image acquisition device. The location determination apparatus 800 includes an image acquisition module 801, a first determination module 802, and a second determination module 803. The image acquisition module 801 is configured to acquire a target image of a target object with an image acquisition device. The first determination module 802 is configured to determine a pixel coordinate of the target object in an image coordinate system based on the target image. The second determination module 803 is configured to determine a world coordinate of the target object in a world coordinate system based on the pixel coordinate and a homography matrix of the image acquisition device. The homography matrix of the image acquisition device is determined according to the calibration method according to implementations of the present disclosure.

In an implementation, the second determination module 803 is further configured to: determine a distance between the target object and the preset location based on the world coordinate of the target object in the world coordinate system and a coordinate of a preset location in the world coordinate system after determining the world coordinate of the target object in the world coordinate system.

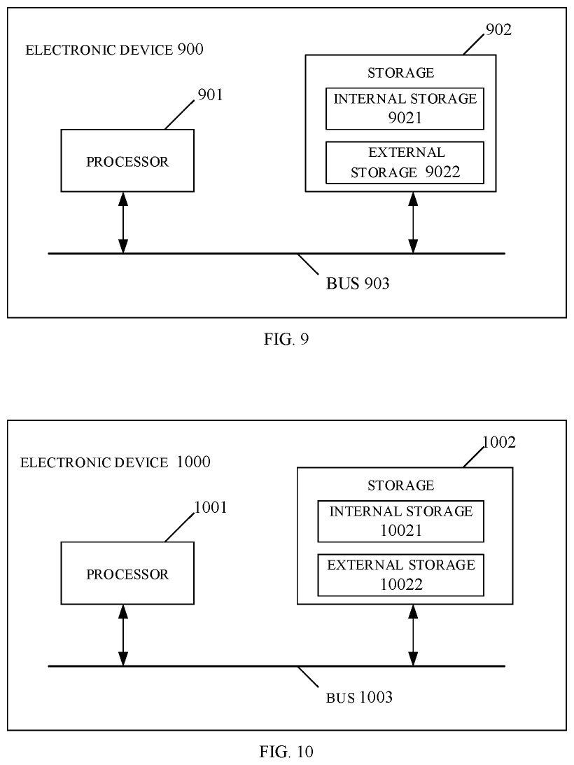

An electronic device 900 corresponding to the calibration method as shown in FIG. 1 is provided according to implementations of the present disclosure. FIG. 9 is a schematic structural diagram of the electronic device according to implementations of the present disclosure. The electronic device includes a processor 901, a storage 902, and a bus 903. The storage 902 is configured to store executable instructions and includes an internal storage 9021 and an external storage 9022. Here, the internal storage 9021, also called an internal memory, is configured to temporarily store arithmetic data in the processor 901 and data exchanged with the external storage 9022 such as a hard disk. The processor 901 performs data exchange with the external storage 9022 through the internal storage 9021. When the electronic device 900 is running, the processor 901 communicates with the storage 902 through the bus 903 and executes the executable instructions to: acquire a sample image with an image acquisition device, determine initial pixel coordinates of multiple sample reference objects in the sample image in an image coordinate system based on the sample image, perform straight-line fitting on sample reference objects on a same straight line based on the determined initial pixel coordinates of the sample reference objects in the image coordinate system, and correct the initial pixel coordinates of the sample reference objects involved in straight-line fitting based on fitted straight lines to obtain corrected pixel coordinates, and determine a homography matrix of the image acquisition device based on world coordinates of the multiple sample reference objects in the sample image in a world coordinate system and the obtained corrected pixel coordinates.

An electronic device 1000 corresponding to the location determination method as shown in FIG. 6 is provided according to implementations of the present disclosure. FIG. 10 is a schematic structural diagram of the electronic device according to implementations of the present disclosure. The electronic device includes a processor 1001, a storage 1002, and a bus 1003. The storage 1002 is configured to store executable instructions and includes an internal storage 10021 and an external storage 10022. Here, the internal storage 10021, also called an internal memory, is configured to temporarily store arithmetic data in the processor 1001 and data exchanged with the external storage 10022 such as a hard disk. The processor 1001 performs data exchange with the external storage 10022 through the internal storage 10021. When the electronic device 1000 is running, the processor 1001 communicates with the storage 1002 through the bus 1003 and executes the executable instructions to: acquire a target image of a target object with an image acquisition device, determine a pixel coordinate of the target object in an image coordinate system based on the target image, determine a world coordinate of the target object in a world coordinate system based on the pixel coordinate and a homography matrix of the image acquisition device. The homography matrix of the image acquisition device is determined according to the calibration method of the first aspect.

A computer-readable storage medium is provided according to implementations of the present disclosure. The computer-readable storage medium is configured to store computer programs. When executed by a processor, the computer programs are configured to perform operations of the calibration method the location determination method according to implementations of the present disclosure.

A computer program product is provided for the calibration method or the location determination method according to implementations the present disclosure. The computer program product includes a computer-readable storage medium configured to store program codes. Instructions in the program codes can be used to perform operations of the calibration method or the location determination method, specifically referring to the method implementations, which will not be repeated here.

It can be clearly understood by those of ordinary skill in the art that, for convenience and brevity, specific operation processes of systems and apparatuses above may refer to the corresponding processes in method implementations, which will not be repeated here. In some implementations of the present disclosure, it should be understood that the disclosed systems, apparatuses, and methods may be implemented in another manner. Apparatus implementations described above are only schematic. For example, division of units is only logic function division, and other division manners may be adopted during practical implementation. For another example, multiple units or components may be combined or integrated into another system, or some features may be emitted or not executed. In addition, coupling or direct coupling or communication connection between displayed or discussed components may be indirect coupling or communication connection through some communication interfaces between apparatuses or units, and may be electrical, mechanical, or other forms.

Units described as separate parts may or may not be physically separated, and parts displayed as units may or may not be physical units, and namely may be in the same place, or may be distributed to multiple network units. Part or all of the units may be selected to achieve the purpose of the solutions of the implementations according to a practical requirement.

In addition, functional units in implementations of the present disclosure may be integrated into a processing unit, each unit may also be physically independent, or two or more units may be integrated into one unit.

When realized in form of software functional units and sold or used as independent products, the functions may be stored in a non-volatile computer-readable storage medium executable by the processor. Based on such an understanding, the technical solutions of the present disclosure substantially or parts making contributions to the related art or parts of the technical solutions may be embodied in form of software product, and the computer software product is stored in a storage medium, including multiple instructions configured to enable a computer device, which may be a personal computer, a server, a network device, or the like, to execute all or part of the operations of the methods in implementation of the present disclosure. The storage medium includes various media capable of storing program codes such as a U disk, a mobile hard disk, a read-only memory (ROM), a random-access memory (RAM), a magnetic disk, or an optical disk.

Finally, it should be noted that the above-mentioned implementations are only examples of the present disclosure, which are used to illustrate the technical solutions of the present disclosure but not to limit, and the scope of the present disclosure is not limited thereto. Although the present disclosure has been described in detail with reference to the foregoing implementations, it should be understood by those of ordinary skill in the art that, without departing from the technical scope of the present disclosure, any person of ordinary skill in the art can modify or change the technical solutions described in the foregoing implementations, or replace some of the technical features with equivalent technical features. However, modifications, changes, or replacements do not cause the essence of the corresponding technical solutions to deviate from the spirit and scope of the technical solutions of the implementations of the present disclosure, and should be covered within the scope of the present disclosure. Therefore, the scope of the present disclosure shall be subject to the scope of the claims.

What is claimed is:

1. A calibration method, comprising:
acquiring a sample image with an image acquisition device;
determining, based on the sample image, initial pixel coordinates of a plurality of sample reference objects in the sample image in an image coordinate system;
performing straight-line fitting, based on the determined initial pixel coordinates of the sample reference objects in the image coordinate system, on sample reference objects on a same straight line, and correcting, based on fitted straight lines, the initial pixel coordinates of the sample reference objects involved in straight-line fitting, to obtain corrected pixel coordinates; and
determining, based on world coordinates of the plurality of sample reference objects in the sample image in a world coordinate system and the obtained corrected pixel coordinates, a homography matrix of the image acquisition device.

2. The method of claim 1, wherein performing straight-line fitting, based on the determined initial pixel coordinates of the sample reference objects in the image coordinate system, on the sample reference objects on the same straight line, and correcting, based on the fitted straight lines, the initial pixel coordinates of the sample reference objects involved in straight-line fitting, to obtain the corrected pixel coordinates comprises:
performing straight-line fitting, based on the determined initial pixel coordinates of the sample reference objects in the image coordinate system, on the sample reference objects on each straight line in a first direction respectively, to obtain a plurality of first fitted straight lines;
correcting, based on the plurality of first fitted straight lines, the initial pixel coordinates of the sample reference objects in the image coordinate system, to obtain intermediate pixel coordinates, and performing straight-line fitting, based on the intermediate pixel coordinates of the sample reference objects, on the sample reference objects on each straight line in a second direction respectively, to obtain a plurality of second fitted straight lines, wherein each straight line in the first direction intersects each straight line in the second direction; and
obtaining, based on the plurality of first fitted straight lines and the plurality of second fitted straight lines, the corrected pixel coordinates.

3. The method of claim 2, wherein each initial pixel coordinate comprises an initial first coordinate value and an initial second coordinate value, and a first coordinate axis corresponding to the initial first coordinate value is perpendicular to a second coordinate axis corresponding to the initial second coordinate value, and wherein:
correcting, based on the plurality of first fitted straight lines, the initial pixel coordinates of the sample reference objects in the image coordinate system, to obtain the intermediate pixel coordinates comprises:
for each sample reference object, substituting the initial first coordinate value of the initial pixel coordinate into a straight-line equation of the first fitted straight line where the sample reference object is located, to obtain an intermediate second coordinate value, the intermediate pixel coordinate of the sample reference object comprising the initial first coordinate value and the intermediate second coordinate value of the sample reference object; and
performing straight-line fitting, based on the intermediate pixel coordinates of the sample reference objects, on the sample reference objects on each straight line in the second direction respectively, to obtain the plurality of second fitted straight lines comprises:
performing straight-line fitting, based on the initial first coordinate values and the intermediate second coordinate values in the intermediate pixel coordinates of the sample reference objects, on the sample reference objects on each straight line in the second direction respectively, to obtain the plurality of second fitted straight lines.

4. The method of claim 2, wherein obtaining, based on the plurality of first fitted straight lines and the plurality of second fitted straight lines, the corrected pixel coordinates comprises:
assigning pixel coordinates corresponding to intersections of the plurality of first fitted straight lines and the plurality of second fitted straight lines as the corrected pixel coordinates.

5. The method of claim 3, wherein the first coordinate axis is a horizontal axis of the image coordinate system and the second coordinate axis is a vertical axis of the image coordinate system, or the first coordinate axis is the vertical axis of the image coordinate system and the second coordinate axis is the horizontal axis of the image coordinate system.

6. The method of claim 1, further comprising:
acquiring a plurality of test images with the image acquisition device after determining the homography matrix of the image acquisition device;
determining, for each test image, test pixel coordinates of test reference objects in the test image in the image coordinate system;
determining, based on the test pixel coordinates and the homography matrix, test world coordinates of the test reference objects in the world coordinate system; and
determining, based on real-world coordinates and the test world coordinates of the test reference objects in the plurality of test images, an accuracy of the homography matrix.

7. The method of claim 1, further comprising:
acquiring a target image of a target object with the image acquisition device;
determining, based on the target image, a pixel coordinate of the target object in the image coordinate system; and
determining, based on the pixel coordinate and the homography matrix of the image acquisition device, a world coordinate of the target object in the world coordinate system.

8. The method of claim 7, further comprising:
determining, based on the world coordinate of the target object in the world coordinate system and a coordinate of a preset location in the world coordinate system, a distance between the target object and the preset location after determining the world coordinate of the target object in the world coordinate system.

9. An electronic device, comprising:
a processor;
a bus; and
a storage configured to store machine-readable instructions to be executed by the processor, wherein when the electronic device is running, the processor communicates with the storage through the bus, and the processor executes the machine-readable instructions to:
acquire a sample image with an image acquisition device;
determine, based on the sample image, initial pixel coordinates of a plurality of sample reference objects in the sample image in an image coordinate system;
perform straight-line fitting, based on the determined initial pixel coordinates of the sample reference objects in the image coordinate system, on sample reference objects on a same straight line, and correct, based on fitted straight lines, the initial pixel coordinates of the sample reference objects involved in straight-line fitting, to obtain corrected pixel coordinates; and
determine, based on world coordinates of the plurality of sample reference objects in the sample image in a world coordinate system and the obtained corrected pixel coordinates, a homography matrix of the image acquisition device.

10. The electronic device of claim 9, wherein the processor, which executes the machine-readable instructions to perform straight-line fitting, based on the determined initial pixel coordinates of the sample reference objects in the image coordinate system, on the sample reference objects on the same straight line, and correct, based on the fitted straight lines, the initial pixel coordinates of the sample reference objects involved in straight-line fitting, to obtain the corrected pixel coordinates, executes the machine-readable instructions to:
perform straight-line fitting, based on the determined initial pixel coordinates of the sample reference objects in the image coordinate system, on the sample reference objects on each straight line in a first direction respectively, to obtain a plurality of first fitted straight lines;
correct, based on the plurality of first fitted straight lines, the initial pixel coordinates of the sample reference objects in the image coordinate system, to obtain intermediate pixel coordinates, and perform straight-line fitting, based on the intermediate pixel coordinates of the sample reference objects, on the sample reference objects on each straight line in a second direction respectively, to obtain a plurality of second fitted straight lines, wherein each straight line in the first direction intersects each straight line in the second direction; and
obtain, based on the plurality of first fitted straight lines and the plurality of second fitted straight lines, the corrected pixel coordinates.

11. The electronic device of claim 10, wherein each initial pixel coordinate comprises an initial first coordinate value and an initial second coordinate value, and a first coordinate axis corresponding to the initial first coordinate value is perpendicular to a second coordinate axis corresponding to the initial second coordinate value, and wherein:
the processor, which executes the machine-readable instructions to correct, based on the plurality of first fitted straight lines, the initial pixel coordinates of the sample reference objects in the image coordinate system, to obtain the intermediate pixel coordinates, executes the machine-readable instructions to:
for each sample reference object, substitute the initial first coordinate value of the initial pixel coordinate into a straight-line equation of the first fitted straight line where the sample reference object is located, to obtain an intermediate second coordinate value, the intermediate pixel coordinate of the sample reference object comprising the initial first coordinate value and the intermediate second coordinate value of the sample reference object; and
the processor, which executes the machine-readable instructions to perform straight-line fitting, based on the intermediate pixel coordinates of the sample reference objects, on the sample reference objects on each straight line in the second direction respectively, to obtain the plurality of second fitted straight lines, executes the machine-readable instructions to:
perform straight-line fitting, based on the initial first coordinate values and the intermediate second coordinate values in the intermediate pixel coordinates of the sample reference objects, on the sample reference objects on each straight line in the second direction respectively, to obtain the plurality of second fitted straight lines.

12. The electronic device of claim 10, wherein the processor, which executes the machine-readable instructions to obtain, based on the plurality of first fitted straight lines and the plurality of second fitted straight lines, the corrected pixel coordinates, executes the machine-readable instructions to:
assign pixel coordinates corresponding to intersections of the plurality of first fitted straight lines and the plurality of second fitted straight lines as the corrected pixel coordinates.

13. The electronic device of claim 11, wherein the first coordinate axis is a horizontal axis of the image coordinate system and the second coordinate axis is a vertical axis of the image coordinate system, or the first coordinate axis is the vertical axis of the image coordinate system and the second coordinate axis is the horizontal axis of the image coordinate system.

14. The electronic device of claim 9, wherein the processor further executes the machine-readable instructions to:
acquire a plurality of test images with the image acquisition device after determining the homography matrix of the image acquisition device;
determine, for each test image, test pixel coordinates of test reference objects in the test image in the image coordinate system;
determine, based on the test pixel coordinates and the homography matrix, test world coordinates of the test reference objects in the world coordinate system; and
determine, based on real-world coordinates and the test world coordinates of the test reference objects in the plurality of test images, an accuracy of the homography matrix.

15. The electronic device of claim 9, wherein the processor further executes the machine-readable instructions to:
acquire a target image of a target object with the image acquisition device;
determine, based on the target image, a pixel coordinate of the target object in the image coordinate system; and
determine, based on the pixel coordinate and the homography matrix of the image acquisition device, a world coordinate of the target object in the world coordinate system.

16. The electronic device of claim 15, wherein the processor further executes the machine-readable instructions to:
determine, based on the world coordinate of the target object in the world coordinate system and a coordinate of a preset location in the world coordinate system, a distance between the target object and the preset location after determining the world coordinate of the target object in the world coordinate system.

17. A non-transitory computer-readable storage medium storing a computer program which, when executed by a processor, causes the processor to:
acquire a sample image with an image acquisition device;
determine, based on the sample image, initial pixel coordinates of a plurality of sample reference objects in the sample image in an image coordinate system;
perform straight-line fitting, based on the determined initial pixel coordinates of the sample reference objects in the image coordinate system, on sample reference objects on a same straight line, and correct, based on fitted straight lines, the initial pixel coordinates of the sample reference objects involved in straight-line fitting, to obtain corrected pixel coordinates; and
determine, based on world coordinates of the plurality of sample reference objects in the sample image in a world coordinate system and the obtained corrected pixel coordinates, a homography matrix of the image acquisition device.

18. The non-volatile computer-readable storage medium of claim 17, wherein the computer program, executed by the processor to perform straight-line fitting, based on the determined initial pixel coordinates of the sample reference objects in the image coordinate system, on the sample reference objects on the same straight line, and correct, based on the fitted straight lines, the initial pixel coordinates of the sample reference objects involved in straight-line fitting, to obtain the corrected pixel coordinates, is executed by the processor to:
perform straight-line fitting, based on the determined initial pixel coordinates of the sample reference objects in the image coordinate system, on the sample reference objects on each straight line in a first direction respectively, to obtain a plurality of first fitted straight lines;
correct, based on the plurality of first fitted straight lines, the initial pixel coordinates of the sample reference objects in the image coordinate system, to obtain intermediate pixel coordinates, and perform straight-line fitting, based on the intermediate pixel coordinates of the sample reference objects, on the sample reference objects on each straight line in a second direction respectively, to obtain a plurality of second fitted straight lines, wherein each straight line in the first direction intersects each straight line in the second direction; and
obtain, based on the plurality of first fitted straight lines and the plurality of second fitted straight lines, the corrected pixel coordinates.

19. The non-volatile computer-readable storage medium of claim 18, wherein each initial pixel coordinate comprises an initial first coordinate value and an initial second coordinate value, and a first coordinate axis corresponding to the initial first coordinate value is perpendicular to a second coordinate axis corresponding to the initial second coordinate value, and wherein:
the computer program, executed by the processor to correct, based on the plurality of first fitted straight lines, the initial pixel coordinates of the sample reference objects in the image coordinate system, to obtain the intermediate pixel coordinates, is executed by the processor to:
for each sample reference object, substitute the initial first coordinate value of the initial pixel coordinate into a straight-line equation of the first fitted straight line where the sample reference object is located, to obtain an intermediate second coordinate value, the intermediate pixel coordinate of the sample reference object comprising the initial first coordinate value and the intermediate second coordinate value of the sample reference object; and
the computer program, executed by the processor to perform straight-line fitting, based on the intermediate pixel coordinates of the sample reference objects, on the sample reference objects on each straight line in the second direction respectively, to obtain the plurality of second fitted straight lines, is executed by the processor to:
perform straight-line fitting, based on the initial first coordinate values and the intermediate second coordinate values in the intermediate pixel coordinates of the sample reference objects, on the sample reference objects on each straight line in the second direction respectively, to obtain the plurality of second fitted straight lines.

20. The non-volatile computer-readable storage medium of claim 18, wherein the computer program, executed by the processor to obtain, based on the plurality of first fitted straight lines and the plurality of second fitted straight lines, the corrected pixel coordinates, is executed by the processor to:
assign pixel coordinates corresponding to intersections of the plurality of first fitted straight lines and the plurality of second fitted straight lines as the corrected pixel coordinates.
